(19) United States
(12) Patent Application Publication
(10) Pub. No.: US 2007/0005479 A1
(43) Pub. Date: Jan. 4, 2007

(54) Enterprise portfolio simulation system

(75) Inventors: Yuichi Ikeda, Mito-shi (JP); Shigeru Kawamoto, Hitachi-shi (JP); Osamu Kubo, Pittsburgh, PA (US); Chihiro Fukui, Hitachinaka-shi (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Tokyo (JP)

(21) Appl. No.: 11/477,777

(22) Filed: Jun. 30, 2006

(30) Foreign Application Priority Data
Jul. 4, 2005 (JP) 2005-195380

(51) Int. Cl. G06Q 40/00

(52) U.S. Cl. 705/35

(57) ABSTRACT

This enterprise portfolio simulation system includes the mechanisms of selecting companies having a large mutual influence from a company's own project portfolio, a business partner company, other competing companies, and still other companies giving an influence on the company's own project portfolio, the business partner company, and the other competing companies; configuring a company network with the own company, the business partner company, and the other competing companies; making each of the own company, the business partner company, and the other competing companies perform a reasonable intention decision while mutually giving an influence; and performing a numerical experiment of an economic activity.

### BACKGROUND OF THE INVENTION

1. Field of the Invention

The present invention relates to an enterprise portfolio simulation system for responding to a management need of a strategic risk especially such as a demand prediction error, a provision of a product not matching a market, a pressure due to a competition, and a problem due to an integration after an M&A (Merger & Acquisition) in an enterprise risk management.

2. Description of the Related Art

Recently, in a remarkable enterprise risk management (hereinafter referred to as ERM) is pointed out an importance of integrally grasping a risk not according to individual risks such as a strategic risk, an operation risk, and a financial risk as well as individual enterprises of an enterprise portfolio but according to a whole enterprise portfolio of a company. A paradigm of the ERM relates to a management technology as a “scheme aiming at a profit cash flow in the future,” strategically involving an uncertainty while effectively utilizing a relationship between the uncertainty and an opportunity and that between a risk and a return. In the US a pervasion of the ERM is proceeding, and also in Japan a positive activity is seen such that a development project of an enterprise risk evaluation and management human resource nurture of the Ministry of Economy, Trade and Industry is performed. Accordingly, it is thought that a need will emerge that performs an enterprise plan preparation and an enterprise evaluation, considering an enterprise portfolio, business partner companies surrounding the portfolio, trends of other competing companies, and various risks.

An advanced case of a US company performing a management paradigm of the ERM is described in non patent document of “Strategic Risk Management of Making Profit—Success Case of US Excellent Company—”(Author: T. L. Burton, W. G. Shenker, P. L. Walker; Translator: Takeaki KARIYA, Tsutomu SATO, Masayuki FUJITA, Publisher: Toyo Economy Shinpo Company, Published year, 2003).

The conventional technology relates to a thinking way and case introduction of the ERM, and a simulation system for performing the ERM is not thought to practically exist therein.

In a conventional simulation system an enterprise plan was independently prepared, based on a subjective prospect with respect to each enterprise. As the result, an achievement prospect of an enterprise portfolio of own company was often mistaken. In addition, in evaluating an enterprise plan by Monte Carlo simulation, fluctuation ranges of a sales and a cost of goods sold (hereinafter referred to as volatility) were subjectively set. As the result, the volatility was often set so as to be able to obtain a desirable result for a person in charge who makes an evaluation. With respect to an enterprise portfolio, because an enterprise correlation cannot be considered, a reliability of the result further lowers.

The above cause exists in that there was no model adequate for predicting reactions of business partner companies and competing companies for an enterprise plan of a company's own project portfolio.

A problem of the present invention is to make it possible to perform a simulation relating to benchmarks such as an enterprise plan preparation, where a company's own project as well as reactions of business partner companies and competing companies are simultaneously considered; and volatilities of a sales and a cost of goods sold where an enterprise correlation is considered.

### SUMMARY OF THE INVENTION

The above problem can be solved by assuming a company to be an agent model; configuring a company agent network with a company's own project portfolio, a business partner company, a competing company, and other “background” companies (hereinafter referred to as BG companies) having a close connection with achievements of the company's own project portfolio, the business partner company, and the competing company; using a risk model that gives an expected value and a covariance matrix as typical risk scales with respect to a return on investment (hereinafter referred to as ROI), a return on equity (hereinafter referred to as ROE), a sales, and a cost of goods sold; performing an economic activity while the agents mutually give an influence; and simulating an achievement of the enterprise portfolio.

### BRIEF DESCRIPTION OF THE DRAWINGS

FIG. 1 is an illustration drawing showing a processing configuration of an enterprise portfolio simulation related to an embodiment of the present invention.

FIG. 2 is a block diagram showing an example of a system configuration of devices performing an enterprise portfolio simulation related to an embodiment of the present invention.

FIG. 3 is an illustration drawing showing a screen example of activation buttons of an enterprise portfolio simulation related to an embodiment of the present invention.

FIG. 4 is an illustration drawing showing an input example of attribute data of an enterprise portfolio simulation related to an embodiment of the present invention.

FIG. 5 is an illustration drawing showing a display example of P agent candidates of an enterprise portfolio simulation related to an embodiment of the present invention.

FIG. 6 is an illustration drawing showing a display example of BG agent candidates of an enterprise portfolio simulation related to an embodiment of the present invention.

FIG. 7 is an illustration drawing showing an example of a company network conceptual drawing of an enterprise portfolio simulation related to an embodiment of the present invention.

FIG. 8 is an illustration drawing showing an example of a PL template of an enterprise portfolio simulation related to an embodiment of the present invention.

FIG. 9 is an illustration drawing showing an example of a BS template of an enterprise portfolio simulation related to an embodiment of the present invention.

FIG. 10 is an illustration drawing showing an example of macroeconomic indices of an enterprise portfolio simulation related to an embodiment of the present invention.

FIG. 11 is an illustration drawing showing an example of a schematic tree of an H agent in an enterprise portfolio simulation related to an embodiment of the present invention.

FIG. 12 is an illustration drawing showing an example of a detailed tree of an H agent in an enterprise portfolio simulation related to an embodiment of the present invention.

FIG. 13 is an illustration drawing showing an example of an input guide for assisting a selection of a business category name of an enterprise portfolio simulation related to an embodiment of the present invention.

FIGS. 14A, 14B, and 14C are respective illustration drawings showing concepts of decision trees of an H agent in an enterprise portfolio simulation related to an embodiment of the present invention.

FIG. 15 is an illustration drawing showing a concept of a game tree of P and C agents in an enterprise portfolio simulation related to an embodiment of the present invention.

FIG. 16 is a flowchart of a generation of a modification plan according to a game theory related to an embodiment of the present invention.

FIG. 17 is a flowchart showing a Monte Carlo simulation procedure with respect to each H agent.

FIG. 18 is a flowchart showing a Monte Carlo simulation procedure with respect to each P and C agent.

FIG. 19 is a graph showing a sales transition of a C agent.

FIG. 20 is a graph showing an NPV (Net Present Value) distribution of a C agent.

### BEST MODE FOR CARRYING OUT THE INVENTION

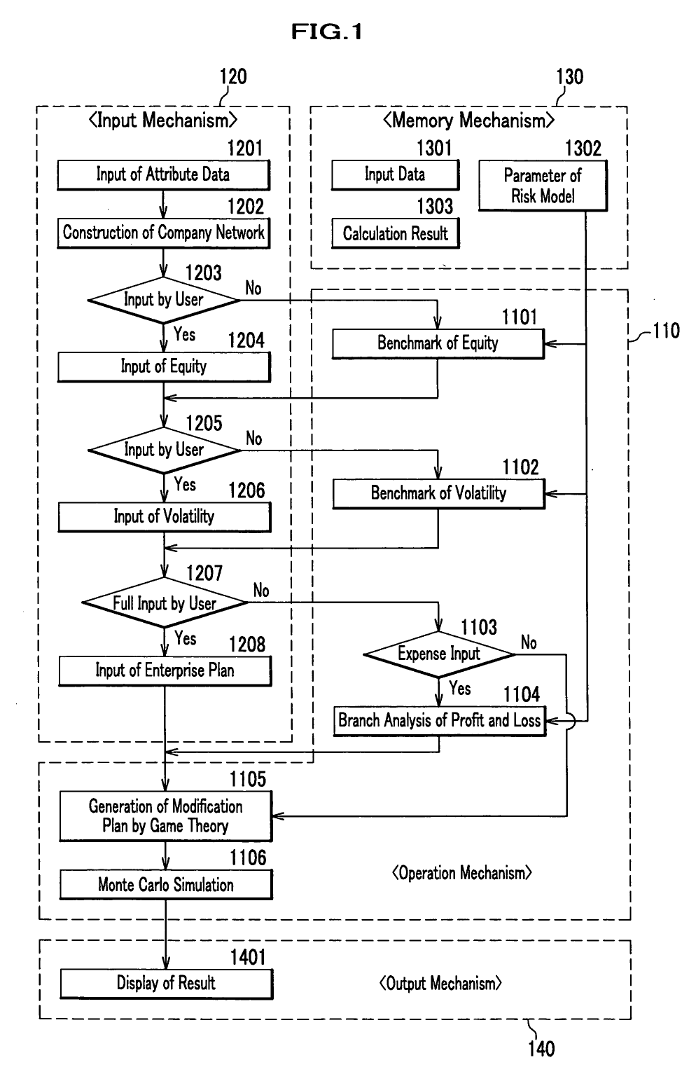

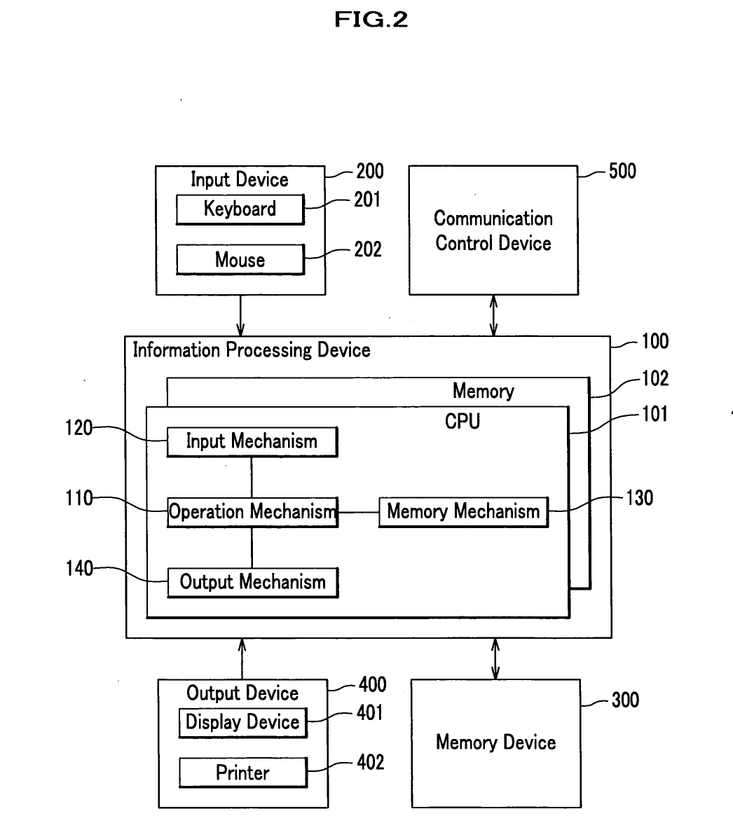

Here will be described an embodiment in a case of performing an enterprise portfolio simulation with using the present invention, referring to drawings as needed. An enterprise portfolio simulation system related to the embodiment has such a processing configuration shown in FIG. 1. An example of a system configuration of the enterprise portfolio simulation system is shown in FIG. 2.

The enterprise portfolio simulation system of the embodiment comprises, as shown in FIG. 2, an information processing device 100, an input device 200 connected thereto, a memory device 300, an output device 400, and a communication control device 500 for communicating with other systems via a network.

The information processing device 100 comprises such a central processing unit (CPU) 101, a memory 102, and interface instruments not shown. As shown in FIG. 2, the information processing device 100 functions as an operation mechanism 110, an input mechanism 120, a memory mechanism 130, and an output mechanism 140 by the CPU 101 running a program; and, for example, sequentially performs a simulation, data input control, a data storage for the simulation, and an output of a simulation result by running a simulation program. Selecting companies having a large mutual influence from a company's own project portfolio, a business partner company, other competing companies, and still other companies giving an influence on the company's own project portfolio, the business partner company, and the other competing companies; and configuring a company network with the company's own project portfolio, the business partner company, and the other competing companies while mutually giving an influence, the enterprise portfolio simulation system is realized where each company reasonably decides his intention.

The operation mechanism 110 performs, as shown in FIG. 1, each processing of an equity benchmark 1101, a volatility benchmark 1102, a judgment 1103 whether or not to perform a cost input, a loss-profit analysis 1104 in a case of performing the cost input; and each processing of a modification plan generation 1105 by game theory and a Monte Carlo simulation 1106 according to a program. These are performed, as described later, using a parameter 1302 of a risk model constructed in advance.

The input device 200 is instruments, for example, such as a keyboard, a mouse, and a touch panel not shown, for a human inputting such an instruction and data to the information processing device 100. In the embodiment a keyboard 201 and a mouse 202 are assumed to be equipped. The input mechanism 120 performs a processing of an input from the input device 200.

The input mechanism 120 performs, as shown in FIG. 1, an input processing for an attribute data input 1201 and a company network construction 1202. In addition, according to an input by a user from the input device 200 is performed a processing of an equity input 1204, a volatility input 1206, and an enterprise plan input 1208. Moreover, before each processing of the equity input 1204, the volatility input 1206, and the enterprise plan input 1208, the input mechanism 120 performs judgments 1203, 1205, and 1207 whether to perform the inputs 1204, 1206, and 1208; or each processing of a corresponding benchmark processing by the operation mechanism 110.

The memory device 300 is configured, for example, with a hard disk device and is instruments for readably and writably saving information. For example, the memory device 300 stores a program run in the information processing device 100, data used therein, and data generated therein. In other words, in the memory device 300 is stored a program for functioning as the operation mechanism 110, the input mechanism 120, the memory mechanism 130, and the output mechanism 140. As a program run by the operation mechanism 110 can be cited, for example, the simulation program described before. The memory mechanism 130 performs processings such as a save, read control, and read/write control of such data for the memory device 300. The memory device 300 may be external or built in.

The output device 400 is instruments for mainly visually showing information: for example, such a display device and a printer. In the embodiment the output device 400 comprises both of a display device 401 and a printer 402. To be more precise, as the display device 401 can be cited, for example, a liquid crystal display. Meanwhile, a portable memory device for writing information as digital data can also be included in the output device 400. If the portable memory device reads such data from itself in the information processing device 100, it is positioned as a component of the input device 200. A data output processing to the output device 400 is performed by the output mechanism 140. The output mechanism 140 can perform both of a screen display and a print-out. In addition, the output device 400 also has a function of performing a display of an input screen of when data is input in the input mechanism 120, corresponding to a processing of receiving the input in the input mechanism 120. For example, such a button displayed on a screen for an instruction described later can be cited.

The communication control device 500 is a device for connecting the system and an external system, and controls communications in giving/receiving information with the external system. The control is performed, for example, by the operation mechanism 110.

Next will be sequentially described a simulation processing according to the enterprise portfolio simulation system of the embodiment, referring to FIG. 1.

Firstly, by the output mechanism 140, in the display device 401 of the output device 400 is displayed a button for receiving an activation instruction for a plurality of kinds of processings. The button is identified on a screen by a cursor, and if a click for its selection is performed by such a mouse, an activation instruction is received by the input mechanism 120.

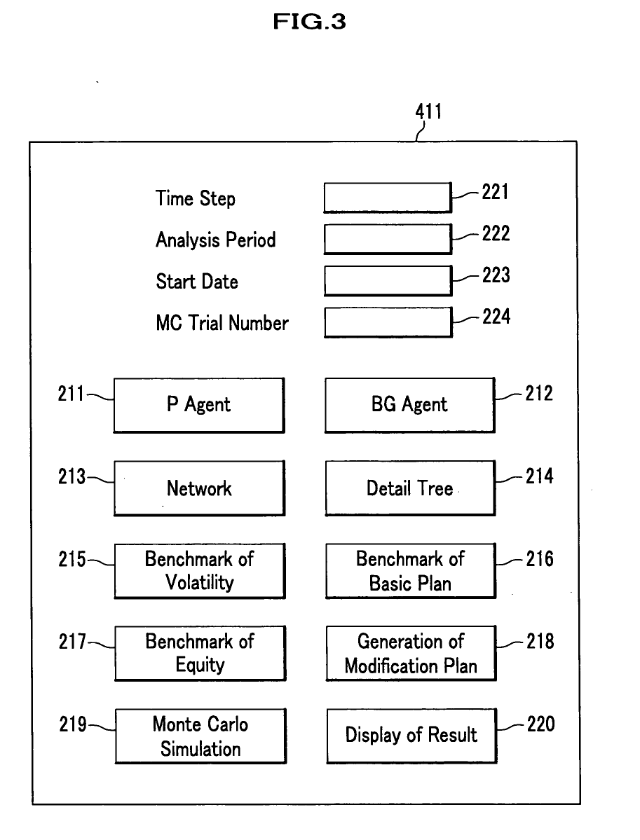

As activation buttons displayed in the display device 401 by the output mechanism 140 are displayed, for example, buttons 211 to 220 shown in FIG. 3. Instead of the activation buttons is also available a configuration of using a pull-down menu. In FIG. 3, as the activation buttons, on a display screen 411 are prepared a P agent 211, a BG agent 212, a network 213, a detail tree 214, a volatility benchmark 215, a basic plan benchmark 216, a stockholder benchmark 217, a modification plan generation 218, a Monte Carlo simulation 219, and a result display 220.

In addition, data input frames 221 to 224 are arranged by the output mechanism 140 on an upper part of the display screen 411 shown in FIG. 3. To be more precise, as frames for inputting are displayed a time step (month, quarter period, half year, year) 221, an analysis period 222, an analysis start date 223, and a Monte Carlo (hereinafter referred to as MC) simulation trial number 224.

A risk model will be firstly described as a preparation for describing each processing. Constructing the risk model by a past financial data analysis, it is assumed to hold a parameter 1302 of the risk model in the memory 102 and the memory device 300 by the memory mechanism 130. As an example, inputting as next a location country of the company i of a company i, a macroeconomic index i, a business category i, and an invested capital i, the risk model is constructed for obtaining an expected value μ(X)i of a sales X as an output. As the location country of the company i of the company i, the macroeconomic index i, the business category i, and the invested capital i used in the construction of the model can be used those input in an attribute data input processing by the input mechanism 120 described later:
μ(Xᵢ)=F(location country of the company i, macroeconomic index i, business category i, invested capital i; parameter group of X) Eq. (1)

Here, as the X, a case of such a cost of goods sold, a sales rate, a cost of goods sold rate, an ROI, and an ROE is similar. The F( ) is an arbitrary function type or an arbitrary table format. Because a company network is a partial system of a whole economy, it also receives an influence from a macroeconomic index.

In addition, inputting the location country of the company i of the company i, the macroeconomic index i, the business category i, and the invested capital i; and a location country of the company j of a company j, a macroeconomic index j, a business category j, and an invested capital j, a risk model is constructed for obtaining a covariance matrix σ(X)ij of the X as an output:
σ(X)ᵢⱼ=G(location country of the company i, macroeconomic index i, business category i, invested capital i; location country of the company j of company j, macroeconomic index j, business category j, invested capital j; parameter group of X) Eq. (2)

Here, the G( ) is an arbitrary function type or an arbitrary table format.

Moreover, inputting the location country of the company i of the company i, the macroeconomic index i, the business category i, and the invested capital i; and the location country of the company j of the company j, the macroeconomic index j, the business category j, and the invested capital j, a risk model is constructed for obtaining an interaction parameter Mij meaning a sales size by a deal between the company i and the company j as an output:
Mᵢⱼ=f(location country of the company i, macroeconomic index i, business category i, scale i; location country of the company j of company j, macroeconomic index j, business category j, scale j; parameter group) Eq. (3)

Similarly, inputting the location country of the company i of the company i, the macroeconomic index i, the business category i, and the invested capital i; and the location country of the company j of the company j, the macroeconomic index j, the business category j, and the invested capital j, a risk model is constructed for obtaining a average value of a sales difference between the company i and the company j as an output:

Here, the f( ) is an arbitrary function type or an arbitrary table type.

If holding a parameter of a risk model in the memory device 300, it is possible by reading the parameter, using the risk models (1) to (3), to perform benchmarks of: volatilities of such a sales and a cost of goods sold; an equity; an interaction between companies; and the like.

The input mechanism 120 in the simulation system of the embodiment performs the processings 1201 to 1208 shown in FIG. 1. The input mechanism 120 shown in FIG. 1 will be described.

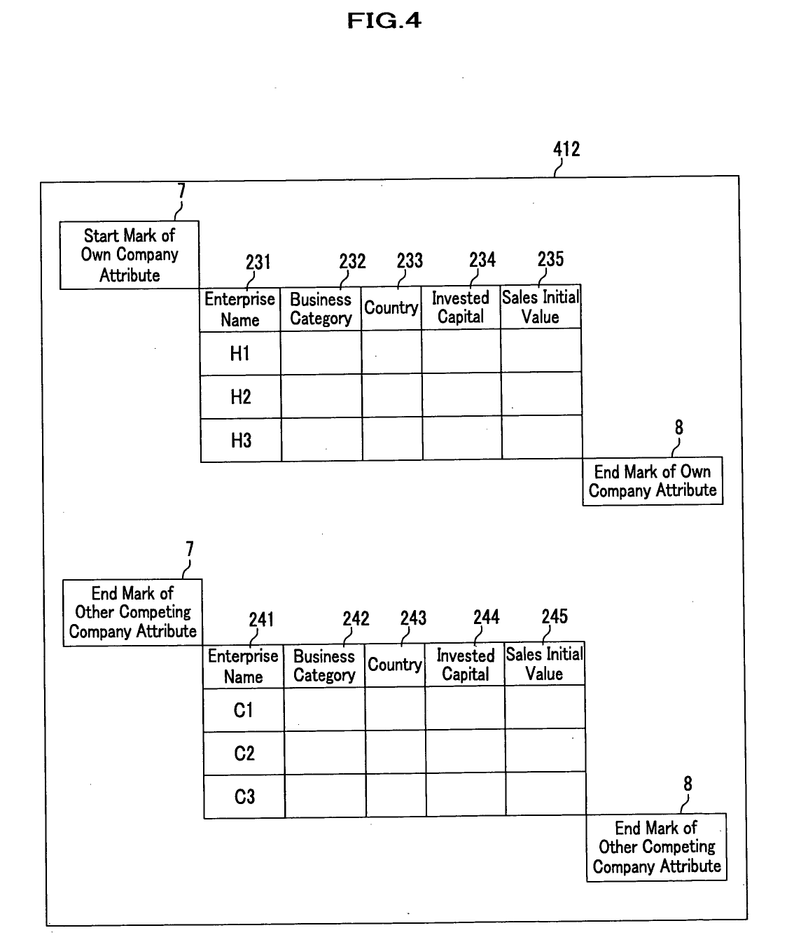

As a first step 1201 of an input shown in FIG. 1, the input mechanism 120 receives, as shown in the upper part of FIG. 3, the time step of the data input (month, quarter period, half year, year) 221, the analysis period 222, the analysis start date 223, the Monte Carlo (hereinafter referred to as MC) simulation trial number 224, and other common basic data inputs not shown. Then the output mechanism 140 makes, as shown in FIG. 4, the display device 401 display an screen 412 for receiving an input with respect to a company's own project division (hereinafter referred to as H agent) and other competing companies (hereinafter referred to as C agent). To be more precise is input attribute data such as enterprise names 231, 241, business categories 232, 242, home countries 233, 243, invested capitals 234, 244, and initial sales (yearly sales in an analysis start year) 235, 245. In the embodiment, although the company's own project divisions are made H1 to H3 and other competing companies C1 to C3, total six agents are assumed, the number is not limited; numbers of H, C agents are arbitrary.

Here, in a case of mounting a system using a spread sheet, in order to be diagonal such as left above and right above of an data input area are prepared marks indicating data areas: own company attribute start mark 7 and own company attribute end mark 8; and other company attribute start mark 7 and other company attribute end mark 8. Meanwhile, for example, something not performed in the system but in another system may also be read in an input according to the spread sheet.

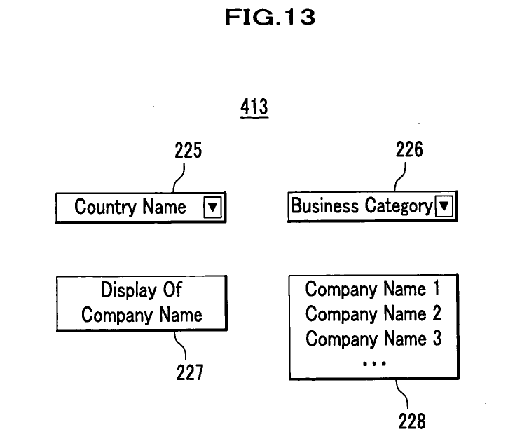

In a selection of a business category name is used an input guide 413 for assisting such a selection as shown in FIG. 13. The guide 413 can be displayed in the screen 412 or other screens. In other words, the output mechanism 140 makes the display device 401 display a screen for respectively selecting a country name from a country menu 225 and a business category from a business category menu 226. The input mechanism 120 receives the selection of the country name and the business category, using the display of the screen. In addition, the output mechanism 140 makes the display device 401 display a company name display button 227. If the input mechanism 120 receives an operation of pushing the company name display button 227, the output mechanism 140 makes the display device 401 display a company name list 228 indicating a company name belonging to the business category in the same screen. Seeing the company name, a user can judge whether or not the business category name is proper.

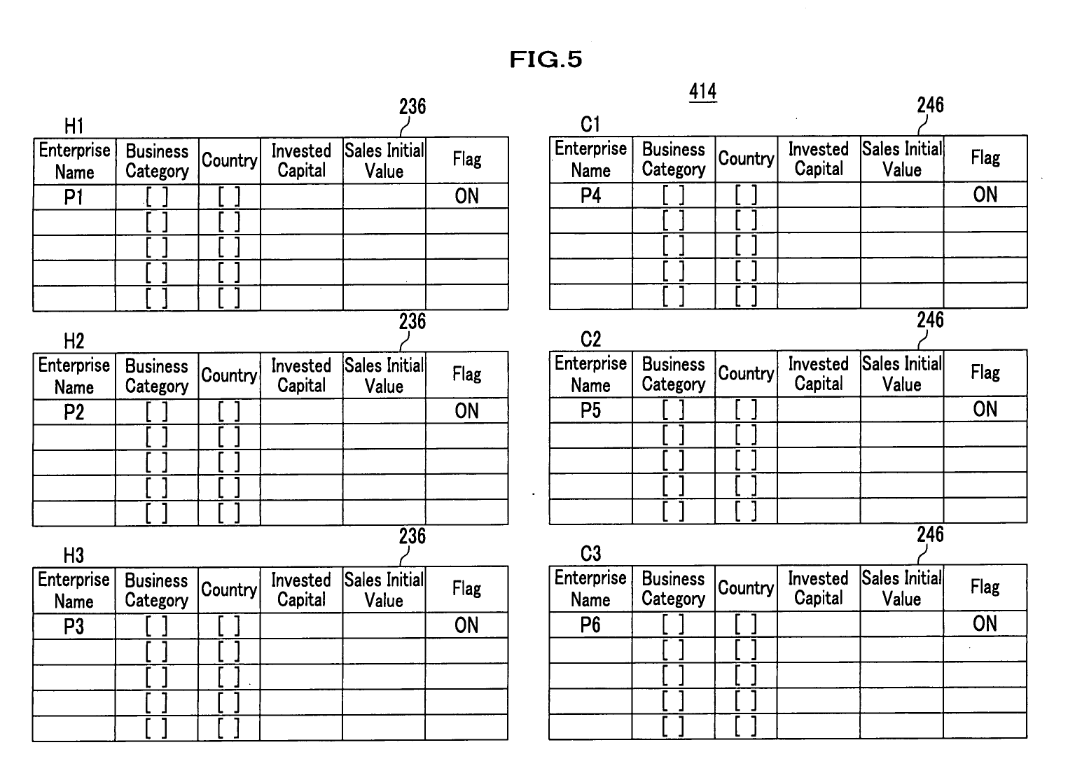

As a second step 1202 of the input is constructed a company network, using such a business partner company (hereinafter referred to as P agent) that is a large company in interaction with the H agent and the C agent. The input mechanism 120 receives an operation of pushing the “P agent” button 211 shown in FIG. 3, that is, a selection instruction with respect to the P agent displayed in the button. Receiving this, the output mechanism 140 makes the display device 401 display candidates of a P agent as shown in FIG. 5. With respect to all of agents H1 to H3 and C1 to C3 are displayed business categories j in descending order of interaction parameters Mij (i=H1 to H3, C1 to C3). Although the P agent is an agent per a company, other competing companies may also be united.

The input mechanism 120 receives an inscription of attribute data of the P agent wanted to be generated by a user out of these candidates. Firstly, the input mechanism 120 receives a check with respect to generation flags 236, 246 (for example, an inscription of ON). In the description, although each one P agent is set with respect to all of the H agent and the C agent, the number is not limited; the number of the P agent is arbitrary.

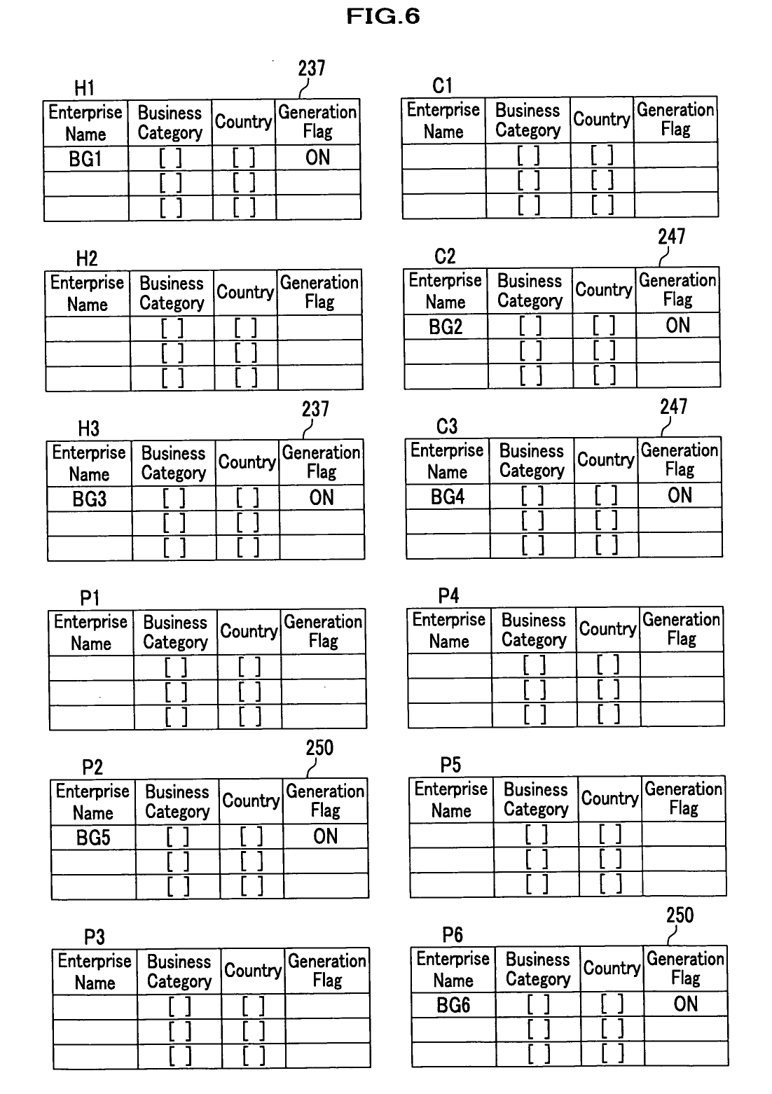

Here, if the input mechanism 120 receives an operation of pushing the “BG agent” button 212 shown in FIG. 3, the output mechanism 140 makes the display device 401 display candidates of the BG agent as shown in FIG. 6. The output mechanism 140 respectively displays the H, P, C agents in descending order of an interaction. In addition, the BG agent is assumed to be a business category agent. Out of these candidates, the input mechanism 120 receives a check of generation flags 237, 247, 250 of the BG agent from a user.

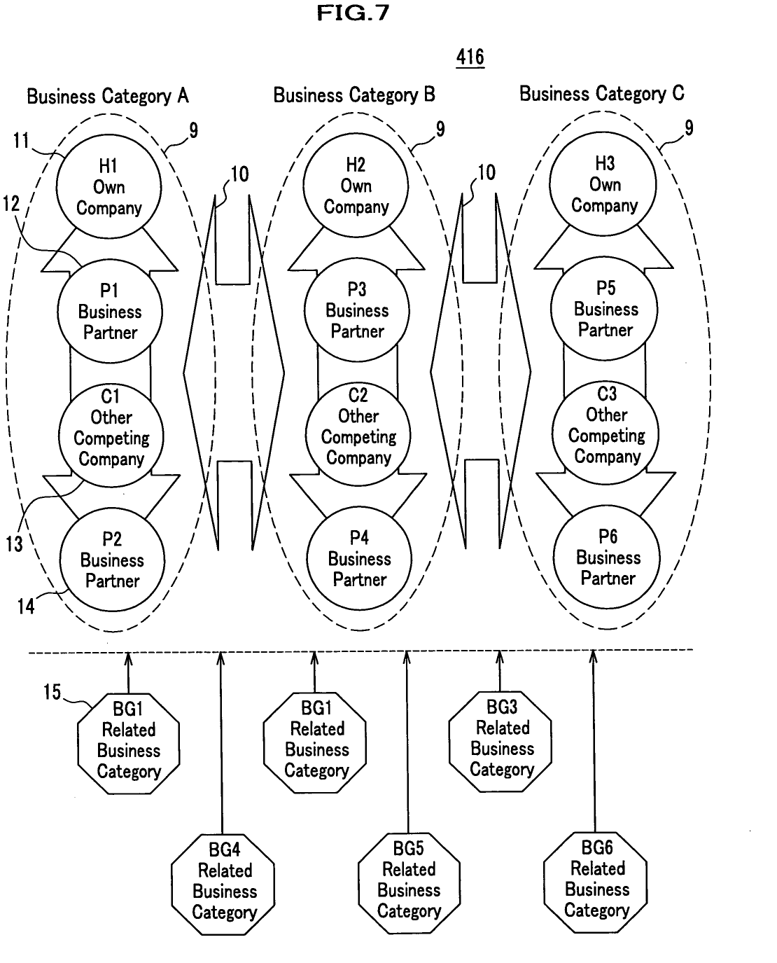

Next, if the input mechanism 120 receives an operation of pushing the “network” button 213 shown in FIG. 3, it constructs a company network composed of agents shown in FIG. 7. In FIG. 7 business categories 9 are respectively indicated with respect to business categories A, B, and C. Interactions 10 respectively exist between the business categories A-B and the business categories B-C. Here, it is assumed that there exists no direct interaction between own company H11 and other competing company C13, and a business partner company P12 and other competing company C13 in each same business category. In addition, in FIG. 7 is shown a BG agent 15 of a related business category. Although FIG. 7 is an illustration drawing, it may also be displayed as a display screen 416.

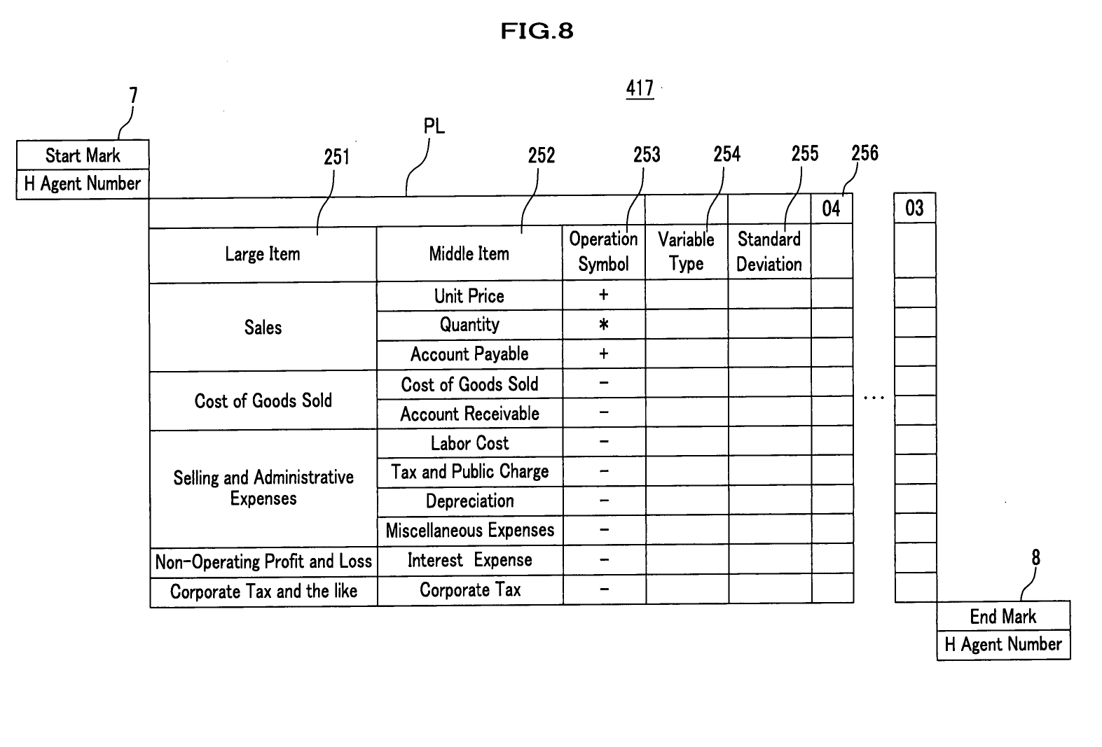

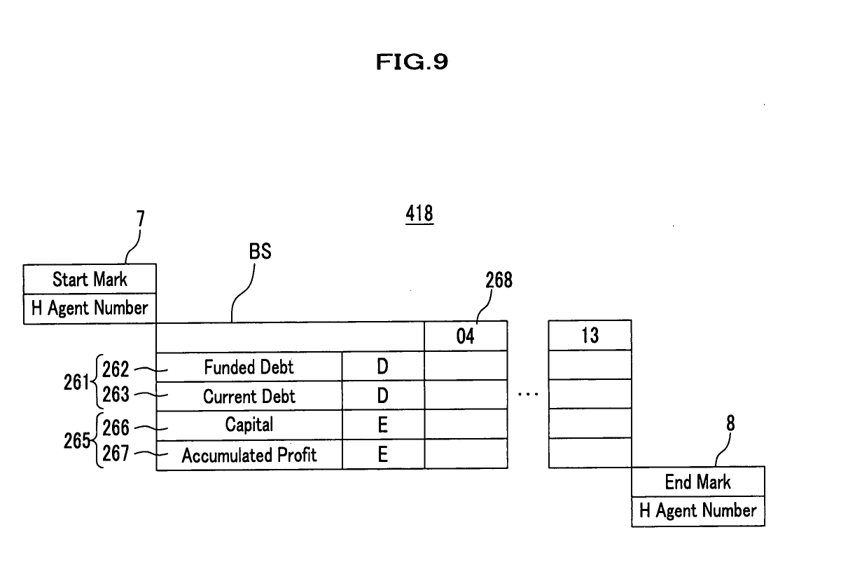

The output mechanism 140 makes the display device 401 display a screen 417 for showing a template of a profit and loss statement (hereinafter referred to as PL) in FIG. 8 and that of a balance sheet (hereinafter referred to as BS) shown in FIG. 9 so as to correspond to the generated H agent. It is also available to automatically make one spread sheet for each H agent and to display the PL template and the BS template therein.

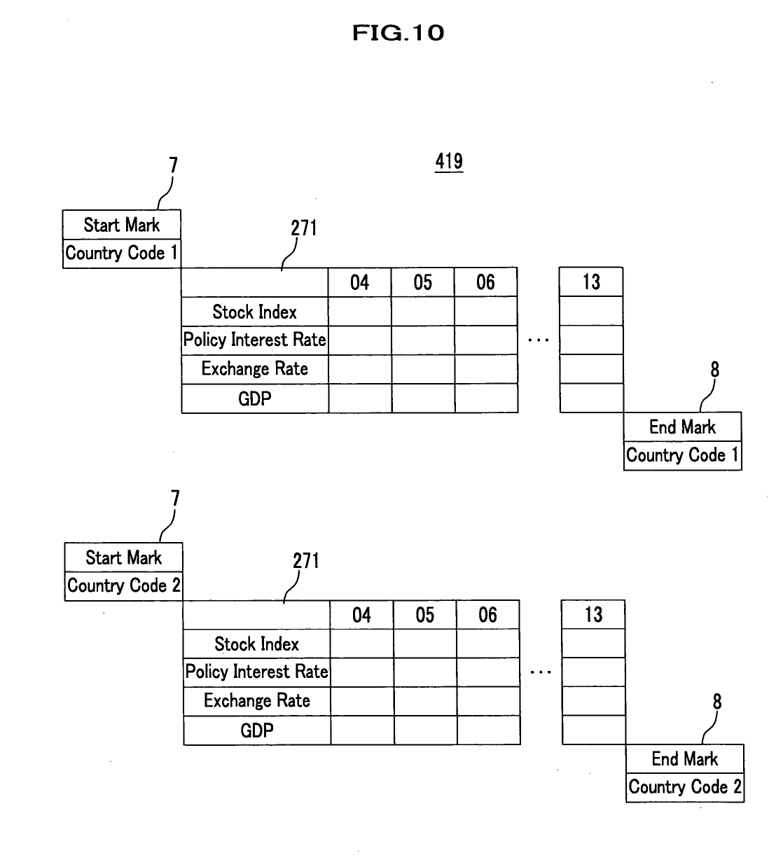

Moreover, the output mechanism 140 makes the display device 401 display a screen 419 for showing a macroeconomic index template as shown in FIG. 10. It is also available to automatically make a spread sheet and display the macroeconomic index template therein. In the template are displayed all home countries of agents configuring the network. In FIG. 10 two countries are displayed. In the macroeconomic index template shown in FIG. 10 is received a predicted value input from the input device 200 by a user with respect to each index for every country. In the embodiment as a macroeconomic index 271 are used a stock index, a policy interest rate, an exchange rate, and a GDP.

Here, if an input is performed by a user, it proceeds to the processings 1204 to 1208 of a next step. As a processing after the third step 1204 in the input mechanism 120, the processing of inputting a basic plan is performed, using a template. As items to be input can be cited the equity input 1204, the volatility input 1206, and the enterprise plan input 1208.

The PL template of the embodiment shown in FIG. 8 has a corresponding table between a large item 251 and a middle item 252, wherein an operation symbol 253, a variable type 254, and a standard deviation 255 are specified with respect to the middle item 252. A large item name is assumed to be unchangeable; a middle item name (an account receivable, an account payable, a depreciation are exceptionally unchangeable) to be changeable. As the large item 251 can be cited such a sales, a cost of goods sold, a marketing expense and an administrative expense, non-operating profit and loss, and a corporate tax. In the middle item 252 are included elements configuring the large item 251 and respectively decided such as a unit price, a quantity, and an account receivable, for example, in a case of the sales. The operation symbol specifies a relationship between elements. The variable type 254 defines what variables those items are. For example, those are defined like a probability variable. In addition, a volatility is set as the standard deviation 255.

A user can add and reduce the middle item 252 as needed through the input device 200. With respect to each item, a user can input a basic plan value 256 of each period through the input device 200. The input mechanism 120 receives each input operation.

In the BS template shown in FIG. 9 a funded debt 262 and a current debt 263 are made a debt (hereinafter referred to as D) 261, and a capital 266 and a profit 267 are made an equity (hereinafter referred to as E) 265. A user can add and reduce an item as needed through the input device 200. A user can input a basic plan value 268 of each period through the input device 200. The input mechanism 120 receives each input operation.

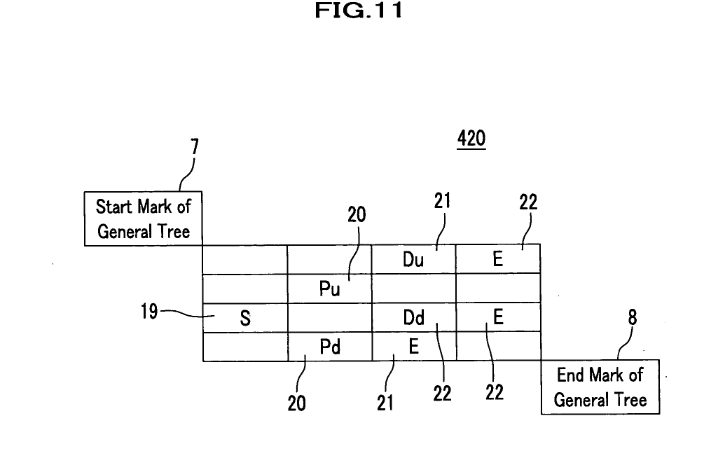

The input mechanism 120 performs a processing of describing a branching and strategy of an achievement scenario of the H agent, using a decision tree.. In the embodiment, although a method of allotting one decision tree for each agent is used, it is also possible to use a method of uniting strategies of all agents and describing them by one decision tree. With respect to each H agent, the input mechanism 120 makes the display device 401 display a general tree screen 420 as shown in FIG. 11 by the output mechanism 140, and receives an input from a user. Symbols used in a general tree are a start point S, an end E, an upper branch Pu of a probability branch node, a lower branch Pd of the probability branch node, an upper branch Du of an intention decision node, a lower branch Dd of the intention decision node. Making a cell of a left adjacent column and a recent access row to be a parent cell, a branched child cell is inscribed. However, a vacant cell is arranged so that there certainly exists one parent cell. In FIG. 11 is shown a result input by a user. With respect to a start point AS 19, the upper branch Pu and lower branch Pd of the probability branch node are arranged at positions 20 branched into two as shown in numerals 20. In addition, the upper branch Du and lower branch Dd of the intention decision node are arranged at positions 21 branched into two. Then with respect to the lower branch Pd of the probability branch node and the upper branch Du and lower branch Dd of the intention decision node are respectively arranged ends E 22.

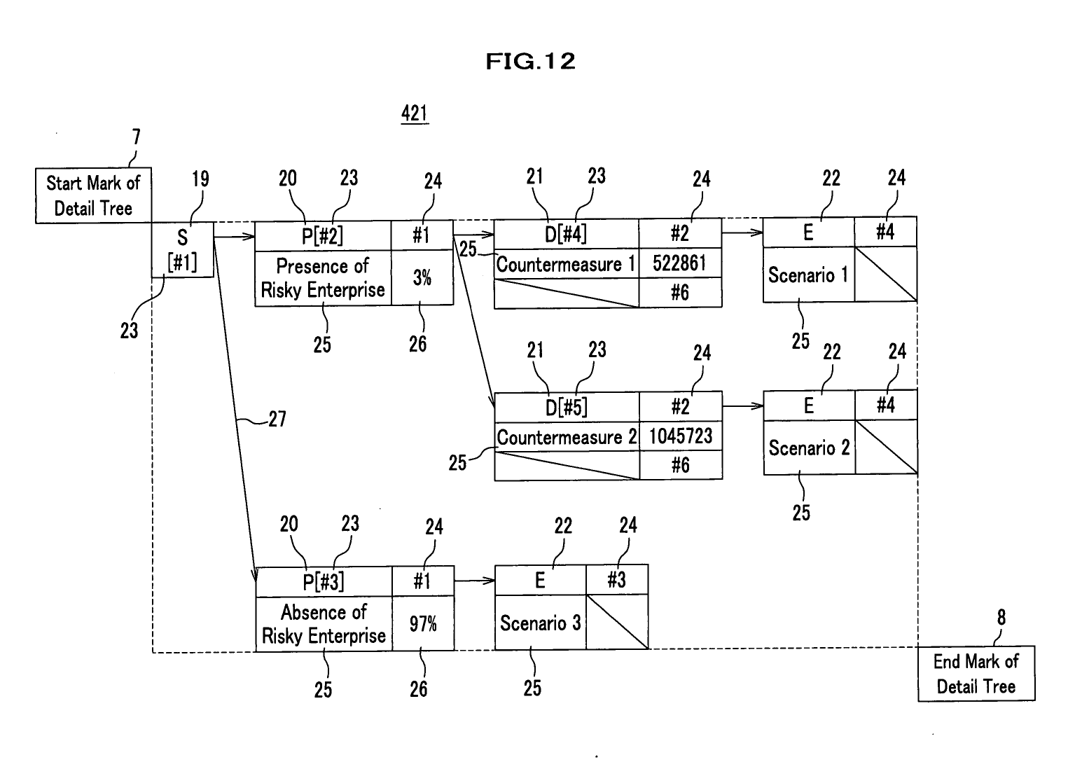

If the input mechanism 120 receives an operation of pushing the “detail tree” button 214 shown in FIG. 3, the output mechanism 140 makes the display device 401 a screen 421 for showing a template of a detail tree as shown in FIG. 12. The input mechanism 120 generates such an address for indicating a node category and a parent-child relationship of the nodes in the template of the detail tree, based on data input in the general tree shown in FIG. 11. As shown in FIG. 12, an arrangement and branching of each node are shown, based on the same position relationship as in FIG. 11.

A requested item is input in the each template, the basic plan and the scenario are identified, and thereby the enterprise plan results in being input (step 1208).

The operation mechanism 110 in a simulation system of the embodiment performs such a processing shown in FIG. 1. According to FIG. 1 will be described the operation mechanism 110. As various pieces of data used in operation are read and used those stored in the memory device 300 as input data 1301 in advance by the memory mechanism 130. In addition, it is also available to receive an input from the input device 200 by the input mechanism 120 as needed. Moreover, a configuration is also available that acquires requested data by the input mechanism 120 via the communication control device 500. In a case of the embodiment the requested data is assumed to be saved in the memory device 300 in advance. In addition, a parameter of a risk model is also assumed to be held as a parameter 1302 of the model in the memory device 300.

With respect to each enterprise i configuring an enterprise portfolio will be described a method of: inputting an invested capital I (I=ΣIi) and a target value of an enterprise profit EBIT in a whole enterprise portfolio; and performing a benchmark of an invested capital Ii and an equity Ei. If receiving an operation of pushing the “equity benchmark” button 216 shown in FIG. 3, the operation mechanism 110 performs the benchmark of the invested capital Ii and the equity Ei according to a procedure described below. In a case of an enterprise portfolio p, because it is not necessary to consider a relationship with other enterprises, an optimum equity is equal to a maximum fluctuation range. In a given invested capital I an equity handling a maximum loss can be derived according to a following equation:
E=N\sqrt{T}\sqrt{σ(ROI)ₚₚI} Eq. (4)
where the σ(ROI)ₚₚI is the variance of the ROI of the enterprise portfolio p calculated according to the equation 2; in addition, the N\sqrt{T} means a scaling factor for multiplying the standard deviation, and the N and the T are respectively a reliability level (for example, 1σ: 68.33%, 3σ: 99.73%) and a period for preparing a risk.

The equity E of the whole enterprise portfolio thus obtained is a constant value (E=\sqrt{Eᵢ}=constant).

Next will be described a method of considering a correlation of a profit in each enterprise configuring an enterprise portfolio, minimizing a risk of the enterprise portfolio in a given target profit rate, and thereby optimizing the invested capital Ii and the equity Ei. In other words, under next two constraint conditions (equations) (5) and (6) is derived the invested capital Ii (i=1 to N) of such an enterprise i that minimizes an objective function

$${\sum }_{ij}^{} {( ROI )}_{ij} ( {T}_{i} / I ) ( {I}_{j} / I )$$

expressing a risk ofthe enterprise portfolio:

$$\begin{matrix}{\sum }_{i}^{} ( {EBIT}_{i} / {T}_{i} ) {I}_{i} / I ) = {\sum }_{i} {EBIT}_{i} / I = ROI target value & Eq . ( 5 ) \\ I = \sum Ii = constant & Eq . ( 6 )\end{matrix}$$

Because an optimum distribution of the invested capital Ii with respect to an enterprise configuring the enterprise portfolio is achieved, next, a distribution problem of the equity Ei to each enterprise i is considered. In other words, under next three constraint conditions (equations) (7), (8), and (9) is derived the equity Ei (i=1 to N) of such the enterprise i that minimizes an objective function

$${\sum }_{ij}^{} σ ( ROE ) ij ( Ei / E ) ( Ej / E )$$

expressing the risk of the enterprise portfolio:

$$\begin{matrix}{\sum }_{i}^{} ( {EBIT}_{i} / {E}_{i} ) {E}_{i} / E ) = {\sum }_{i}^{} {EBIT}_{i} / E = ROE target value & Eq . ( 7 ) \\ 0 < {E}_{i} < {I}_{j} = constant & Eq . ( 8 ) \\ E = \sum {E}_{i} = constant & Eq . ( 9 )\end{matrix}$$

Thus it has become possible to input the target values of the I, E, profit EBIT of the whole enterprise portfolio and to derive the invested capital Ii and the equity Ei of the enterprise i (i=1 to N) configuring such an enterprise portfolio realizing the target values of the ROI and the ROE at a minimum risk.

Next will be described the volatility benchmark 1102 of a sales and a cost of goods sold. Reading the location country of the company i of the company i, the macroeconomic index i, the business category i, and the invested capital i from the memory device 300, inputting them in the equation (2), and using it with respect to change rates of the sales and the cost of goods sold, a diagonal element σ(X)ii of a covariance matrix is derived. A square root of the covariance is a benchmark value of a standard deviation in a geometric Braun process or a geometric Levi process. If receiving an operation of pushing the “volatility benchmark” button 215 shown in FIG. 3, the benchmark value of a standard deviation is output (step 1102) with respect to an item of which a “variable type” is designated as a probability variable in the PL of the H agent shown in FIG. 8. In addition, as described later, also with respect to the C agent, the P agent, and the BG agent, it is respectively requested to give volatilities, and according to a method similar to the above, the benchmark values of standard deviations thereof are output.

Next will be described a benchmark of a basic plan of the H agent where a profit and loss analysis 1104 is used. If the input mechanism 120 receives an operation of pushing the “basic plan benchmark” button 216 shown in FIG. 3, it performs a benchmark processing of the basic plan according to a procedure described below. In the embodiment, in a case that a target of a production number is set and thereby cost is decided, a problem of deriving the basic plan of a sales R(t) according to setting a unit price is taken as an example. A cash flow P(t) of an enterprise is given according to the following equation:
P(t)=(R(t)−N*sales standard deviation)−(C(t)+g(t)+e(t)+N* cost of goods sold standard deviation)−corporate tax−d(t) Eq. (10)
where the R(t), C(t), g(t), e(t), and d(t) are respectively a sales, a cost of goods sold, marketing and administrative expenses, an interest expense, an original principal and a dividend; in addition, N is a stress applied to the standard deviations.

Also in a case of: using more detailed financial items such as a CF (Cash Flow) accompanied with an investment, a new fundraise, a management buyout, and an account receivable and an account payable; and calculating the cash flow P(t), handling thereof is substantially similar.

In addition, describing the sales or the cost of goods sold as X, a standard deviation of the X is given as follows:
σ(X)=\sqrt{σ(X)ᵢⱼ} Eq. (11)
σ(X)ᵢᵢ=G(location country of the company i, macroeconomic index i, business category i, scale i; location country of the company i, macroeconomic index i, business category i, scale i; parameter group of X) Eq. (12)

At this time the profit and loss analysis is to make the C(t), the g(t), the e(t), the d(t), and an initial investment amount as given and the sales R as a variable and to minimize an objective function K expressed in the following equation:

$$K = \sum {tP ( t )}^{⋀} 2 \qquad Eq . ( 13 )$$

However, the minimization is assumed to be performed under the following two constraint conditions (equations):

$$\sum tP ( t ) \cdot initial investment amount > 0 \\ R ( t ) - N * sales standard deviation > C ( t ) + g ( t ) + d ( t + e ( t ) + N * cost of goods sold standard deviation \qquad Eq . ( 15 )$$

The constraint condition (14) means that a net profit is plus, that is, eligible for the investment. Meanwhile, if applying a discount rate, the net profit is equal to a net present value and conceptually more eligible. In addition, the constraint condition (15) means that a cash management in each period is possible.

According to such the method, it is possible to input a cost (decided by a target production number) and to derive the basic plan of the sales R(t) (decided by a unit price) having a possibility of an investment eligibility and a cash management. Its calculation result is stored in the memory device 300 as a calculation result 1303 by the memory mechanism 130.

Next will be described a generation 1105 of a modification plan and an enterprise plan by the operation mechanism 110, using an optimum reaction of a game theory. If receiving an operation of pushing the “modification plan generation” button 218 shown in FIG. 3, the operation mechanism 110 performs the generation of the modification plan and the enterprise plan according to a procedure described below:

Under a given basic plan of the H agent are generated a modification plan of the H agent and an enterprise plan of the P and C agents as a Nash equilibrium solution of the game theory. A scenario of a sales Ri (t) (i=1 to N) of the P and C agents is expressed in the following equation (16) of a difference equation.
Rᵢ(t+Δt)=Rᵢ(t)+ΔRᵢ(t) Eq. (16)
where the Ri(0) is an initial value input in FIG. 4 and FIG. 5.

The difference ARi(t) of the H agent is expressed in a probability differential equation:
ΔRᵢ/Rᵢ(t)=given basic plan−∂U(t)∂Rᵢ+σᵢξᵢ(t) Eq. (17)
where the given basic plan is input, using the PL, the BS, and the decision tree as shown in FIGS. 8, 9, and 12.

In addition, a sales Rq(t) (q=1 to M) and a difference ΔRq(t) of the P and C agents are expressed in a probability differential equation:

$$\begin{matrix}{R}_{q} ( t + Δ t ) = {R}_{q} ( t ) + Δ {R}_{q} ( t ) & Eq . ( 18 ) \\ Δ {R}_{q} / {R}_{q} ( t ) = {\sum }_{k} {D}_{q} {w}_{qk} δ ( t - {t}_{k} ) \cdot \partial U ( t ) / \partial {R}_{q} + {σ}_{q} {ξ}_{q} ( t ) & Eq . ( 19 )\end{matrix}$$

Here, with respect to the H agent, using the equation (19) instead of the equation (17), there exists a method of formulating all of the H, P and C agents according to the equation 19.

Moreover, a difference ∇Ru(t) (u=1 to G) of the BG agent is expressed in a probability differential equation:
Rᵤ(t+Δt)=Rᵤ(t)+ΔRᵤ(t) Eq. (20)
∇Rᵤ/Rᵤ(t)=μᵤ+σᵤξᵤ(t) Eq. (21)

The probability differential equations (16) to (21) are cases of the geometric Braun process classified into the simplest Levi process, and it is also possible to formulate another probability differential equation corresponding to a more exquisite modeling.

The right side first term of the equation (19) means a company action based on a reasonable intention decision. The sales basic plan D_{q}w_{qk}=±D_{q}(k=1 to K) is decided by a sales change width Dq and a transition probability w_{qk}=w_{qk}(V(q)) at an intention decision timing k. The transition probability w_{qk}=w_{qk}(V(q)) depends on a payoff V(q) equal to a money amount where an initial investment amount Iq is subtracted from a sum of a cash flow added up with respect to l=t/Δt:

$$V ( q ) = ( 1 - T ) {\sum }_{l} \{ {R}_{q} ( l Δ t ) - {C}_{q} ( l Δ t ) \} - {I}_{q} \qquad Eq . ( 22 )$$

where the T and the C are respectively a tax rate and a cost of goods sold.

The cost of goods sold C can be derived according to the equation (1) by inputting the location country of the company i of the company i, the macroeconomic index i, the business category i, and the scale i. A payoff V(i) of the H agent can also be calculated similarly to the equation (22). Meanwhile, in the embodiment, although a discount rate is omitted for a simplification in the equation (22), it is also possible to consider the discount rate and use a payoff equal to a net present value. The right side second terms of the equations (17) and (19) are an interaction acting on the agent i.

$$\partial U ( t ) / \partial Ri = \begin{matrix}{\sum }_{j \neq i}^{} {M}_{ij} \{ ( {R}_{i} ( t ) / {R}_{i} ( t - Δ t ) - \\ {R}_{i} ( t ) / {R}_{i} ( t - Δ t ) - ( {μ}_{i} - {μ}_{i} ) \}\end{matrix} \qquad Eq . ( 23 )$$

Each interaction parameter Mij is calculated, using the equation (3). In the embodiment, as an example, it is assumed that there exists no interaction between the H agent and the other competing companies C and between the P agent and the other competing companies C in a same business category, and the H, P, and C agents receive an action from the BG agent. As described here, as a result of each agent receiving an influence from other agents in a mode of the interaction, the sales of the each agent is expressed according to N pieces of simultaneous probability differential equations.

The right side third terms of the equations (17) and (19) are sales fluctuation ranges where the random number ξᵢ is multiplied by the volatility σᵢ. In the embodiment, although a standard normalized random number is used as a distribution shape of the random number ξᵢ, it is not necessary to be limited to a specific distribution, and also possible to use a power law distribution.

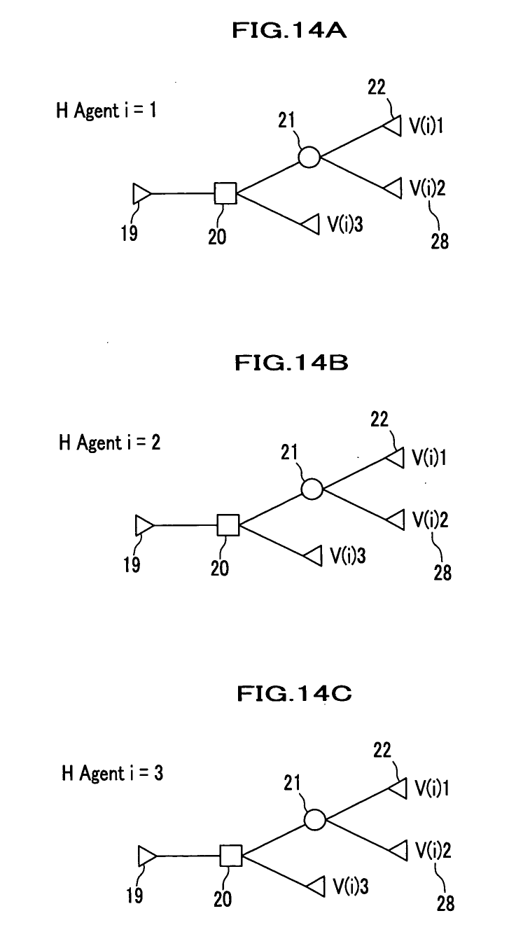

Here will be described a method of deriving the modification plan of the H agent. In a calculation of a transition probability Wᵢₖ is not considered a probable fluctuation of the right side third term of the equation (17). With respect to the H agent, allotting one decision tree to each agent, an input of an enterprise basic plan is received in FIGS. 8, 9, and 12. A total number of the H agent is equal to N (i=1 to N). In addition, a scenario number of the H agent i is equal to s(i) (m=1 to s(i)). Moreover, a scenario number of the whole H agent is equal to S=Πis(i) (r=1 to S). In FIGS. 14A to 14C are shown conceptual drawings of decision trees of the H agent in a case of N=3, s(i)=3, and S=27. In the decision trees the transition probability Wᵢₖ of a probability branch node is given. In addition, the transition probability Wᵢₖ of an intention decision node can be derived, depending on a value of a payoff V(i)m, with using a standard solution method of a decision tree.

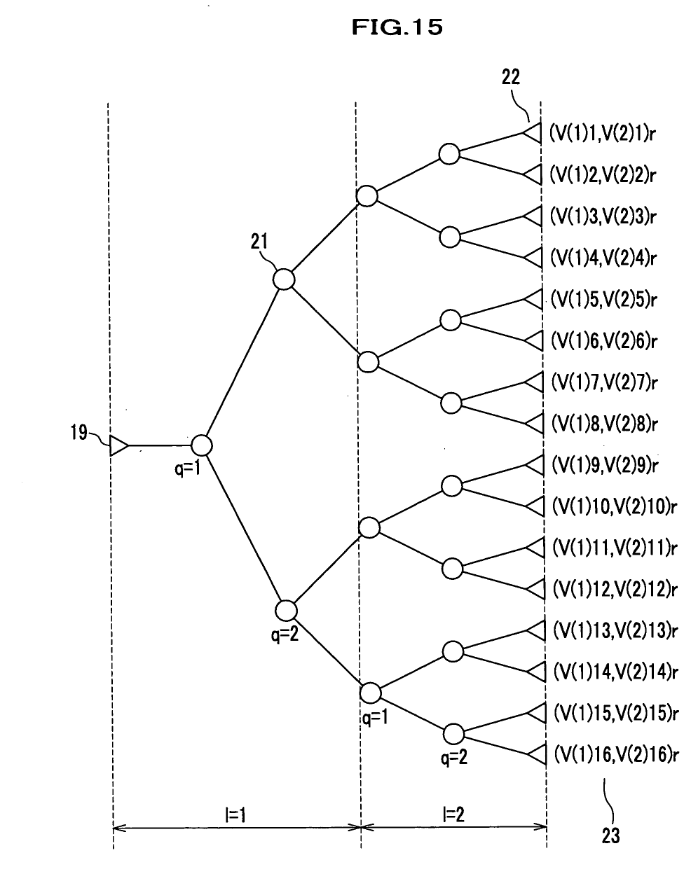

Next will be described a method of deriving an enterprise plan of the P and C agents. In a calculation of the transition probability Wᵢₖ is not considered a probable fluctuation of the right side third term of the equation (19). In the P and C agents are modeled all agents as one game tree. However, the game tree is not input by a user but automatically generated by system. A number of the P and C agents is equal to M (q=1 to M). In addition, a time step number is equal to T (1=1 to T). Moreover, a scenario number of the P and C agents with respect to each scenario r of the H agent is equal to 2ˆM*T (n=1 to 2ˆM*T). However, the symbol ˆ means a power. In the embodiment, although M=12, a concept of a game tree of the P and C agents is shown in FIG. 15 in a case of M=2, T=2, and 2ˆM*T=16. This is to simplify an expression of the drawing, and it is also possible to draw a similar drawing in a case of M=12. It is possible to calculate payoffs (V(1)n, . . . , V(k)n, . . . , V(M)n)j and to derive the transition probability Wᵢⱼ of the P and C agents according to an inverse inference method of the standard solution method of the game theory.

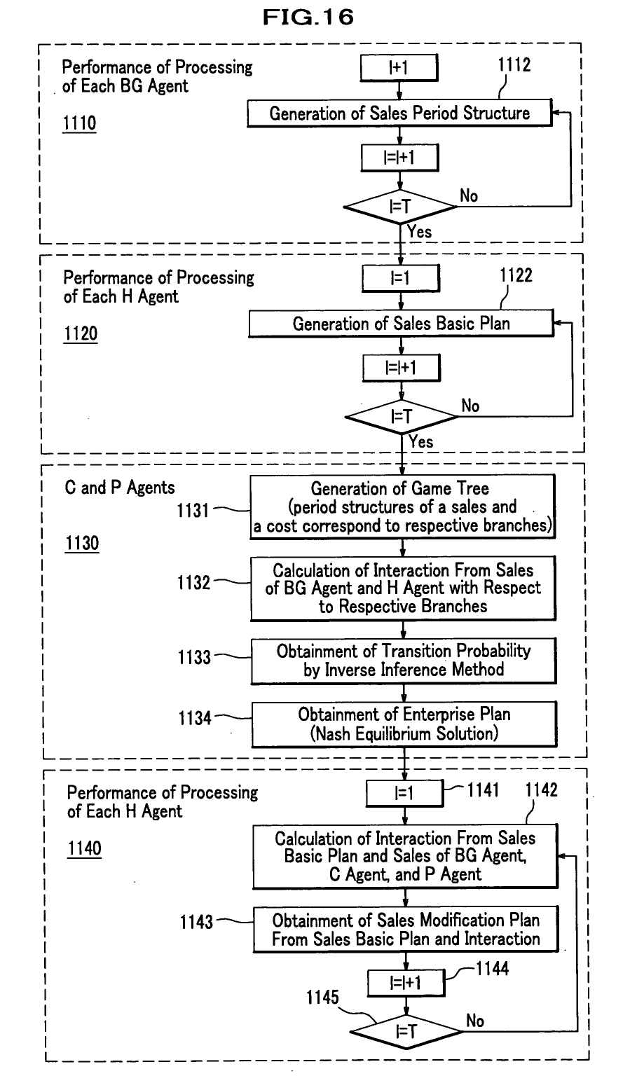

In FIG. 16 is shown a generation flowchart of a modification plan according to the game theory. In an example shown in FIG. 16 the operation mechanism 110 firstly performs a processing 1110 with respect to each BG agent, and here, performs a generation processing 1112 of a sales period structure from (l=1) to (l=T). In addition, the operation mechanism 110 performs a processing 1120 with respect to each H agent, and here, performs a generation processing 1122 of a sales basic plan from (l=1) to (l=T).

Next, the operation mechanism 110 performs a processing 1130 with respect to the P and C agents. In the game tree the sales and cost period structures correspond to respective branches. Next, the operation mechanism 110 performs a processing 1132 of calculating an interaction from the sales of the BG agent and the H agent. Next, based on the obtained result, the operation mechanism 110 performs a processing of deriving a transition probability according to the inverse inference method. Finally, the operation mechanism 110 performs a processing 1134 of obtaining an enterprise plan (Nash equilibrium solution).

Next, the operation mechanism 110 performs a processing 1140 with respect to each H agent. In other words, the operation mechanism 110 performs a processing 1142 of calculating an interaction from the sales basic plan and sales of the BG, P and C agents, and then performs a processing 1143 of deriving a sales modification plan from the sales basic plan and the interaction. The operation mechanism 110 performs these processings 1142, 1143 from (l=1) to (l=T).

If receiving an operation of pushing the “Monte Carlo simulation” button 219, the operation mechanism 110 performs the Monte Carlo simulation according to a procedure described below. Making the scenario of the modification plan of the H agent generated according to the method described above and that of the enterprise plan of the P and C agents to be expected values, and generating sales fluctuation ranges as in the right side third terms in equations (17), (19), and (21), the operation mechanism 110 performs the MC simulation of generating a time sequential scenario of the sales Rᵢ(l∇t) (l=1, 2, . . . ). Using the generated scenario, the operation mechanism 110 calculates a probability distribution of the sale scenario and that of the payoff PVᵢ.

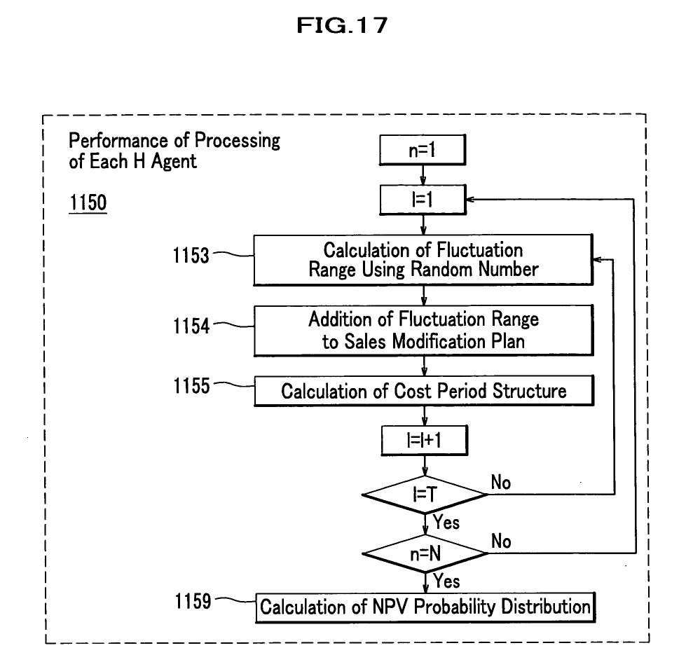

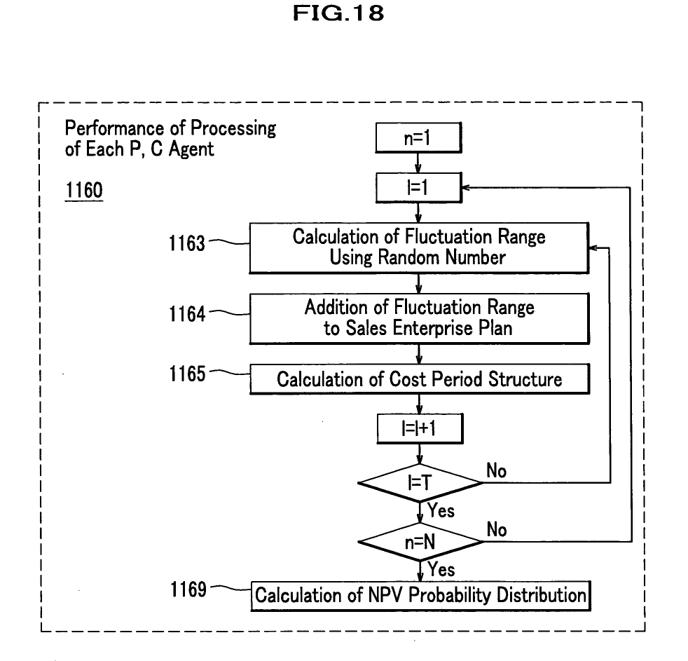

As shown in FIG. 17, the operation mechanism 110 performs a Monte Carlo simulation processing 1150 with respect to each H agent. In other words, from (l=1) to (l=T), the operation mechanism 110 performs a processing 1153 of calculating a fluctuation range, using a random number; a processing 1154 of adding the fluctuation range to the sales modification plan; and a processing 1155 of calculating a cost period structure. In addition, the operation mechanism 110 performs a processing 1159 of making a repletion by number of the agents, that is, from (n=1) to (n=N), and calculating a probability distribution of a net present value (NPV). Similarly, the operation mechanism 110 repeats, as shown in FIG. 18, the MC simulation with respect to each C, P agent: a processing 1163 of calculating a fluctuation range, using a random number; a processing 1164 of adding the fluctuation range to the sales modification plan; and a processing 1165 of calculating a cost period structure.

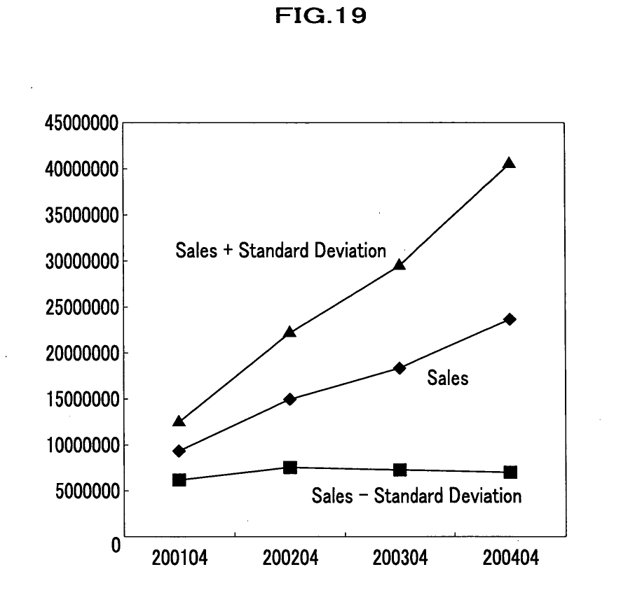

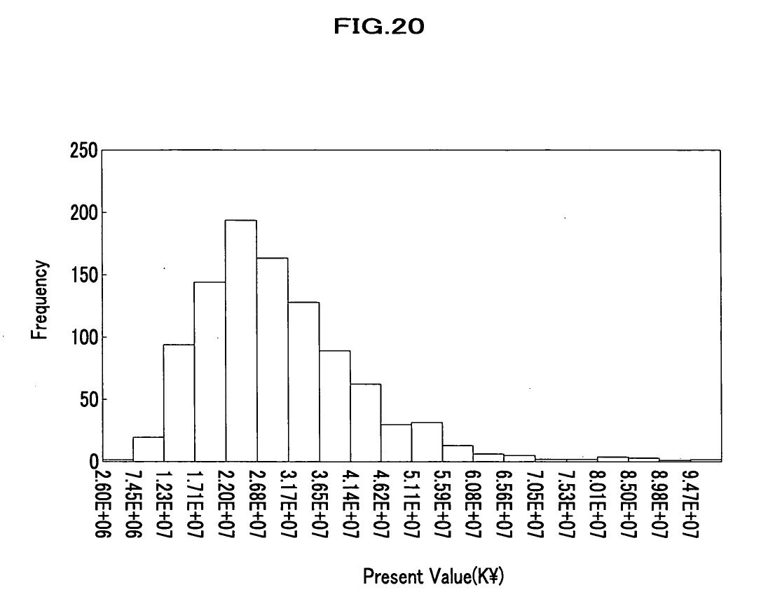

The output mechanism 140 of the embodiment performs the processing shown in FIG. 1. A result display by the output mechanism 140 will be described according to FIG. 1. If the input mechanism 120 receives an operation of pushing the “result display” button 220 shown in FIG. 3, the output mechanism 140 displays a result according to a procedure described below. The output mechanism 140 calculates such a probability distribution of a financial item such as a sales and a cost of goods sold described in the PL and the BS, and that of a present value of an enterprise profit from a time sequential scenario generated by the MC simulation. The output mechanism 140 makes the display device 401 such as a liquid crystal display these results therein. In addition, the output mechanism 140 makes the printer 402 print a drawing and a table therefrom. In addition, also with respect to a realization probability of the modification plan of the H agent input in the decision tree and an enterprise plan corresponding to the Nash equilibrium of the P and C agents, the output mechanism 140 makes it possible to display them in the display device 401 and to perform their printout by the printer 402. For example, FIG. 19 shows a sales transition of the C agent from 2001 to 2004 in three kinds: sales, sales+standard deviation, and sales−standard deviation. FIG. 20 is a graph showing an NPV distribution of the C agent.

What is claimed is:

1. An enterprise portfolio simulation system comprising:
an input mechanism configured to select companies having a large mutual influence from a company's own project portfolio, a business partner company, other competing companies, and still other companies giving an influence on the company's own project portfolio, the business partner company, and the other competing companies and to configure a company network with the own company, the business partner company, and the other competing companies; and
an operation mechanism configured to make each of the own company, the business partner company, and the other competing companies perform a reasonable intention decision while mutually giving an influence and to perform a numerical experiment of an economic activity.

2. The enterprise portfolio simulation system according to claim 1 further comprising:
an output mechanism configured to output a modification plan of the basic plan of the company's own project portfolio,
wherein the input mechanism inputs a basic plan including a sales, a cost of goods sold, and a time transition with respect to the company's own project portfolio, and
wherein the operation mechanism performs the numerical experiment of a reaction of the business partner company, the other competing companies, and the still other companies giving an influence on the companies.

3. The enterprise portfolio simulation system according to claim 1 further comprising:
a memory mechanism configured to hold a model parameter,
wherein the input mechanism inputs a business category, invested capital, and macroeconomic index of a location country of the company of an enterprise configuring the company's own project portfolio,
wherein the operation mechanism uses the model parameter and a risk model constructed in advance by an analysis of past enterprise achievement data, and
wherein the output mechanism outputs a benchmark result of an interaction parameter.

4. An enterprise portfolio simulation system comprising:
an input mechanism configured to input a business category, invested capital, and macroeconomic index of a location country of the company of an enterprise configuring the company's own project portfolio;
a memory mechanism configured to hold a model parameter;
an operation mechanism configured to use the model parameter and a risk model constructed in advance by an analysis of past enterprise achievement data: and
an output mechanism configured to output a benchmark result of a volatility of a sales and a cost of goods sold.

5. The enterprise portfolio simulation system according to claim 4, wherein the input mechanism inputs a business category, invested capital, macroeconomic index of a location country of the company, cost of goods sold, marketing expense and administrative expense, non-operating profit, non-operating loss, and corporate tax of an enterprise configuring the company's own project portfolio; wherein the operation mechanism considers the volatility of the sales and the cost of goods sold corresponding to a characteristic of the enterprise, and wherein the output mechanism outputs a minimum sales where the enterprise works out.

6. An enterprise portfolio simulation system comprising:
an input mechanism configured to input a business category and an invested capital, a macroeconomic index of a location country of the company, a debt, a stress scale of a sales volatility, a period with respect to individual enterprises configuring own company enterprise portfolio; and
an output mechanism configured to output an optimum amount of an equity.

7. An enterprise portfolio simulation system comprising:
an input mechanism configured to input a business category, invested capital, and macroeconomic index of a location country of the company of an enterprise configuring the company's own project portfolio;
an operation mechanism configured to consider a profit correlation in each enterprise and to minimize a risk of an enterprise portfolio under a given target profit rate; and
an output mechanism configured to output an invested capital to the each enterprise and an optimum distribution amount of an equity.
